(19) United States
(12) Patent Application Publication
(10) Pub. No.: US 2016/0267494 A1
(43) Pub. Date: Sep. 15, 2016

(54) TACTILE ANTI-FORGERY METHOD USING RANDOM RAISED STRUCTURES

(71) Applicant: SENSE DIGITAL CO., LTD., Taipei City (TW)

(72) Inventors: Fu-Pi Pao, Taipei City (TW); San-Yuan Wu, Taipei City (TW); Kuan-Ying Pao, Taipei City (TW)

(21) Appl. No.: 15/161,522

(22) Filed: May 23, 2016

Related U.S. Application Data
(63) Continuation-in-part of application No. 14/466,905, filed on Aug. 22, 2014.

(51) Int. Cl. G06Q 30/00; H04W 76/02; G06K 7/10; G06F 17/30; G06K 19/077

(52) U.S. Cl. CPC G06Q 30/0185; G06F 17/30879; G06K 19/07758; G06K 7/10861; H04W 76/02

(57) ABSTRACT

A tactile anti-forgery method using random raised structures that generates a plurality of labels that can be attached to predetermined products, and each label has a unique label serial number, a label planar printed pattern and a plurality of raised structures randomly arranged on the surface of the label. The various label serial numbers and their corresponding information including the distribution locations of the corresponding; raised structures are established in a system database. A user can connect to the system database via an application in a mobile device, and input a label serial number of a label to be tested to search for the distribution information of the raised structures corresponding to the label. Then, the distribution information of the raised structures on the label to be tested are compared against the distribution information provided by the system database to see if they match using the application and the user's visual and tactile recognitions, for example, to see if the quantity, locations and shapes of the raised structures on the label to be tested match with those from the system database, and if the purportedly raised structures truly feel raised when being touched, thereby achieving effective anti-forgery.

### BACKGROUND OF THE INVENTION

1. Field of the Invention

The invention relates to a tactile anti-forgery method, and more particularly, to an improved tactile anti-forgery method that can be used in conjunction with conventional anti-forgery techniques to exploit the tactile sensation created by randomly arranged raised structures provided. on a label as well as visual details attributed to the quantity, the locations and the shapes of the raised structures, allowing an inquirer to verify the label by visually examine and touch it.

2. Description of the Prior Art

Conventional carrier structures (labels) with anti-forgery identification features, for example, as seen in CN Patent Application No. 97126167.9 titled “NATURAL ANTI-FORGERY METHOD”, are made into fixed-sized (square, circular or other shapes) sheets with natural materials such as wood or stone. Each of these inherently characteristic sheets is individually assigned with a random number using a computer, and then the number is printed on the sheet. Then, the textures and patterns of the sheets are scanned and filed for future inquiries.

This type of identification technique is based on the texture of the natural materials (wood or stone). However, under the current manufacturing environment with advanced photographic reproduction techniques, the fact that this type of identification method relies on visual identification of the features may not achieve the anticipated anti-forgery effect.

CN Patent Application No. 99801139.8 titled “STRUCTURAL TEXTURE ANTI-FORGERY METHOD”, WO 200000862 titled “Structure vein anti-counterfeit method”, U.S. Pat. No. 6,623,041 titled “Method for discerning false from genuine” or U.S. Pat. No. 8,488,842 (US 2013/0022238 titled “Systems and methods for tracking and authenticating goods” use materials having unambiguous and random structural textures as anti-forgery identification objects that utilize the random structural textures as anti-forgery information. The anti-forgery information are scanned or recorded with a scanning device and stored in a computer identification database. Consumers may obtain information about the structural textures via communication tools such as phones, faxes or networked computers to verify the genuineness of the texture information of the products.

The abovementioned random structural texture refers to a random texture integrated into an artificial carrier structure. For example, filaments are added into paper pulp in which the distribution of the filaments is used as anti-forgery information. However, this type of anti-forgery labels can be counterfeited by providing similar visual effects of the features using the current printing (including stamping) techniques, such that an inquirer may find it difficult to distinguish between a printed counterfeit and filaments unless the filaments are stripped off the carrier, Doing so requires time and effort and may easily damage the anti-forgery label. Moreover, the above random structural texture does not provide significant undulation (height differences) that is noticeable with human touch, so the inquirer cannot distinguish the sizes, the shapes and the locations of the random structural textures by touch.

Moreover, in CN Patent Application No. 200910135421.4 titled “ANTI-FORGERY METHOD OF STRUCTURAL TEXTURE”, an anti-forgery mark is numbered and provided with a random texture given by angle-dependent color-shifting fibers. The feature of this random texture and the number are stored in a database for consumers to verify the genuineness of the random texture feature. Since it is impossible to counterfeit the angle-dependent color-shifting fibers by printing, the anti-forgery effectiveness of this type of texture is largely improved.

However, the anti-forgery method just mentioned can still be counterfeited to some extent with the current photocopying printing techniques, causing visual confusion to an inquirer, such that the inquirer may not immediately ascertain if the label is a printed counterfeit. This is a practical shortcoming.

In view of the shortcomings in the prior art, the present invention is proposed to provide improvements that address the aforementioned shortcomings.

### SUMMARY OF THE INVENTION

One main objective of the present invention is to provide a tactile anti-forgery method using random raised structures randomly arranged on an anti-forgery label. The raised structures have the sizes and characteristics of Braille. In addition to tactile sensation, an inquirer can also identify the quantity, shapes and locations of the raised structures through tactile recognition, and also see if the raised structures match with the distribution information of the raised structures provided by the system through visual recognition, thus providing a verification mechanism that combines two sensations, overcoming the shortcoming of causing visual confusion to the users by faking traditional planar anti-forgery mechanisms using photographic reproduction techniques.

Another objective of the present invention is to provide a tactile anti-forgery method using random raised structures that can be combined with existing anti-forgery mechanism(s) in practice, such that there is no large difference in the overall operation procedure. This not only provides ease of use, but also achieves a better anti-forgery effect.

In order to achieve the above objectives and effects, the technical means employed by the present invention may include: generating a plurality of labels that can be attached to predetermined products, each label including a unique label serial number, a label planar printed pattern and a plurality of raised structures randomly arranged on the label surface; establishing distribution information of the raised structures corresponding to the various label serial numbers in a system database; allowing a mobile device to connect to the system database via an application to obtain the distribution information of the raised structures corresponding to the label serial number on a label to be tested on a product; performing label visual recognition, tactile recognition and distribution information recognition of the raised structures; allowing a user to determine if the raised structures of the label to be tested and the distribution information of the raised structures provided by the system database are the same by visual recognition; allowing the user to determine if the raised structures of the label to be tested and the distribution information of the raised structures provided by the system database are the same by tactile recognition; and the user determining the product with the label to be tested is authentic when the visual recognition and the tactile recognition indicate the raised structures of the label to be tested and that provided by the system database are the same; else, the product is counterfeit.

Based on the method above, the raised structures include providing a plurality of predetermined three-dimensional (3D) structures on the surface of the label, and each 3D structure has a size that allows visual or tactile identification of its quantity, location and size by a to person.

Based on the method above, the step of “generating a plurality of labels that can be attached to products, each label including a unique label serial number, a label planar printed pattern and a plurality of raised structures randomly arranged on the label surface”, the system database records the label planar printed pattern, and images of the surface of the label where the raised structures are randomly provided thereon, forming the distribution information of the raised structures.

Based on the method above, the label planar printed pattern has a fixed style, and the label planar printed pattern is used for displaying the label serial number, a product name, a logo, providing connection information required for connecting with the predetermined system database or a description of the raised structures, allowing the user to know the label planar printed pattern in advance and clearly identify the raised structures in the image of the label.

Based on the method above, the label planar printed pattern. has no fixed style, and the image of the surface of the label is recorded before the raised structures are randomly arranged thereon, and then the image of the surface of the label is recorded again after the raised structures are provided, and by comparing the differences between images before and after the provision of the raised structures, the user is able to clearly identify the raised structures.

Based on the method above, in the step of “performing label visual recognition, tactile recognition and distribution information recognition of the raised structures”, the application obtains the distribution information of the raised structures of the label to be tested using a photographic module provided in the mobile device.

Based on the method above, the application performs image processing on the distribution information of the raised structures of the label to be tested and the distribution information provided by the system database, so that the two distribution information of these raised. structures have the same viewing conditions on a screen of the mobile device.

Based on the method above, the step of “performing label visual recognition, tactile recognition and distribution information recognition of the raised structures” further includes allowing the application to analyze the distribution information of the raised structures of the label to be tested, and compare it with the distribution information in the system database to create a rating information.

Based on the method above, the application may use image processing techniques including image correction, image background removal, features extraction, features identification and determination of the degree of approximation to create rating information, such as the degree of similarity, the degree of approximation, or a fraction, a percentage or a grade (A, B, C, D, E . . . ) of difference, or inconclusive.

Based on the method above, in the step of “allowing a mobile device to connect to the system database via an application to obtain the distribution information of the raised. structures corresponding to the label serial number on a label to be tested on a product”, the application of the mobile device connects to the system database, and the label serial number of the label to be tested is inputted to obtain the distribution information of the corresponding raised structures.

The objectives, effects and features of the present invention can be more fully understood by referring to the drawing as follows:

### BRIEF DESCRIPTION OF THE DRAWINGS

FIG. 1 is a block diagram illustrating a preferred embodiment of the present invention.

FIG. 2 is a flowchart illustrating a preferred embodiment of the present invention.

FIG. 3 is a perspective schematic diagram illustrating a preferred embodiment of the present invention.

### DETAILED DESCRIPTION OF THE PREFERRED EMBODIMENTS

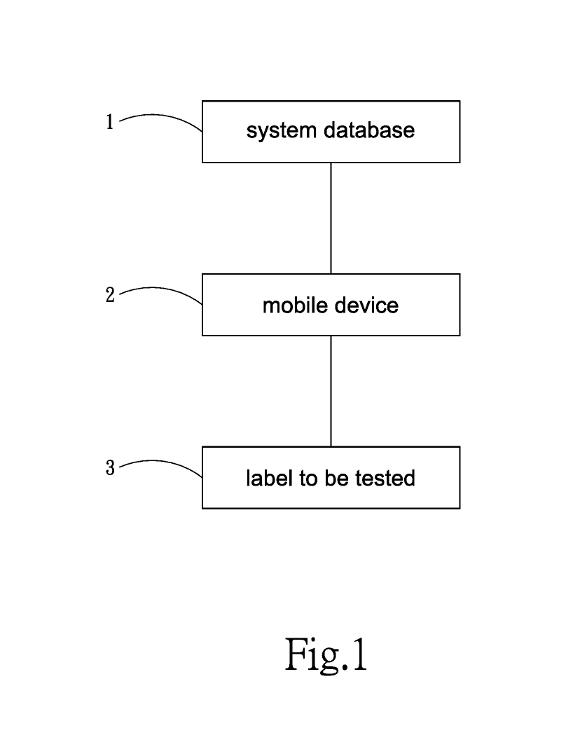

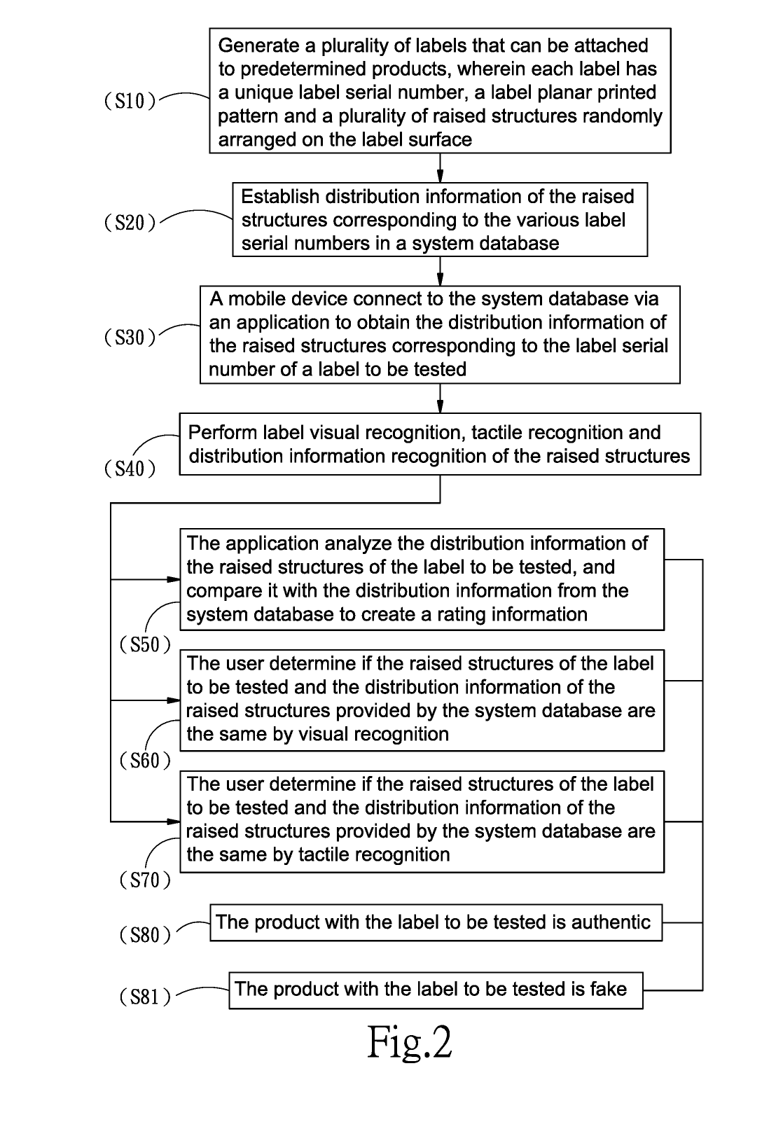

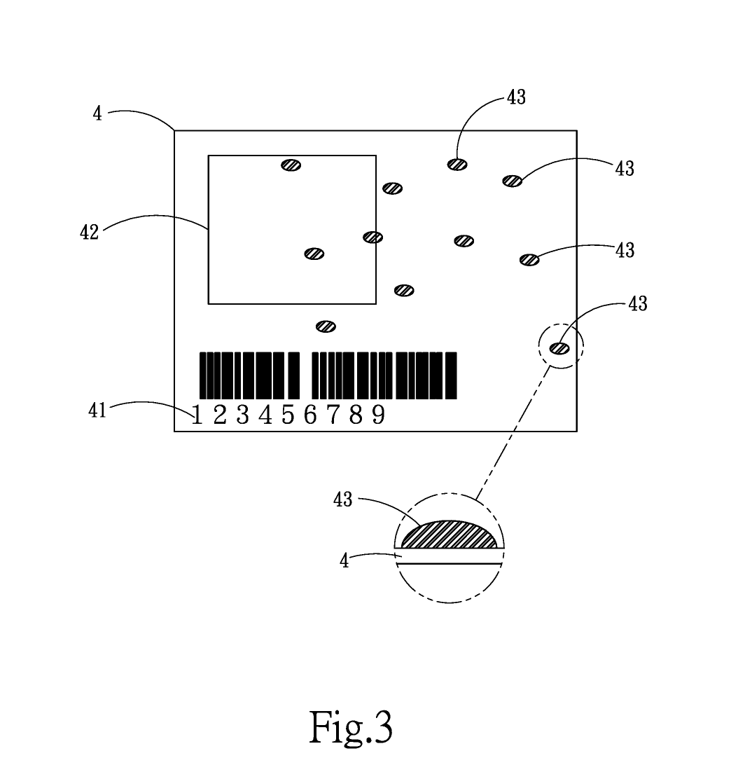

Referring to FIGS. 1, 2 and 3, the present invention includes a system database 1 that allows a mobile device 2 to be connected via a network, The mobile device 2 performs a tactile anti-forgery method using random raised structures on a label to be tested 3 according to the steps described later. It should be noted that the system database 1 means a system constructed after a database is introduced into a computer system (in a network server, a personal computer, or more generally a computer terminal), and generally consists of a database, a database management system and its developing tools, application systems, database manager and users. The database system is a complete computer application system formed by hardware, software (e.g. an operating system, database management system and compiling system), the database and the users. The database is the core of the database system and is subjected to management. Therefore, the meaning of a database system is neither just a software that performs management on data nor just a database, but an implementing system that stores, maintains and provides data support according to the database. The mobile device 2 generally refers to a computer terminal that is portable for the user, such as a smartphone, a tablet, or a laptop computer, and is at least installed. with one or more image capturing device, such as a photographic lens, and can be connected to the Internet via a wireless communication protocol such as 2G, 3G, 4G, WIFI, WIMAX, etc., or a wired communication protocol such as Ethernet or coaxial cable in order to connect with the system database 1. In addition, the mobile device 2 is provided with a screen and an input device. The input device may be a physical T9 keyboard or a QWERTY keyboard, or a liquid crystal touch panel. The label to be tested 3 is a label 4 manufactured according to the steps of the present invention described later, attached to a product, and before being verified by a user according to the steps described below.

A tactile anti-forgery method using random raised structures of the present invention includes the following steps:

(S10) Generating a plurality of labels that can be attached to predetermined products, wherein each label has a unique label serial number, a label planar printed pattern and a plurality of raised structures randomly arranged on the label surface.

The label 4 is a flat piece or sheet (such as a piece of paper, plastic, film or wooden plate), which includes, on its surface, a label serial number 41, and a label planar printed pattern 42. Furthermore, raised structures 43 are a plurality of predetermined 3D structures provided on the surface of the label 4. These 3D structures are scattered on the surface of the label 4 in random numbers and at random locations, and are affixed to the label 4 by adhesives or films to prevent them from peeling off. The 3D structures have such a size that it allows direct visual and tactile recognition of their quantity, locations and shapes, that is, they form a height difference with the surface of the label 4 that convey the feeling of bumps when touched by a person. At the same time, the size of the 3D structures are such that it allows direct visual and tactile recognition of the quantity, locations and shapes of the raised structures 43. They may assume granular, tubular, regular or irregular three-dimensional shapes. It should be noted that, the raised structure 43 of the present invention can also be provided with reference to the specification of Braille system. The size, pitch, kerning, line spacing, and the like of the Braille bumps are set based on physiological and psychological characteristics of blind people. The shape of the bumps is usually hemispherical or parabolic. The diameter of the bottom of the bump is between 1 and 1.6 mm with a height of 0.2˜0.5 mm. if the bumps are too small, it will adversely affect the response speed. if the bumps are too big, it will go beyond the most sensitive area of the fingertips. It should be noted that the although the 3D structures of the present invention may be provided with reference to the configuration and arrangement of Braille, the 3D structures of the present invention is not limited to Braille, any 3D structures that when touched by a person allows he/she to sense it are within the definition of a 3D structure of the present invention.

(S20) Establishing distribution information of the raised structures corresponding to the various label serial numbers in a system database.

The distribution information of the raised structures 43 is established by taking photographs of the label 4 at least once using a camera equipment. Taking photographs may include taking a set of photos from different angles to allow an inquirer to examine it from different viewpoints, or taking or storing photos of different resolutions to allow the inquirer to zoom in on the photos for detailed comparison. it should be noted that, based on the types of equipment actually used, in addition to planar photos, the distribution information of the raised. structures 43 can also be formed by using 3D images generated by a 3D image scanning device or a thickness detection device, such as a multi-lens camera or a 3D scanner, or motion pictures. It should be noted that the label planar printed pattern 42 may have a fixed style, and the label planar printed pattern 42 is used for displaying the label serial number 41, a product name, a logo, providing connection information required for connecting with the predetermined system database or a description of the raised. structures 43, allowing the user to know the label planar printed pattern 42 in advance and clearly identify the raised structures 43 in the image of the label 4. Alternatively, the label planar printed pattern 42 may have no fixed. style. in this case, the image of the surface of the label 4 is recorded before the raised structures 43 are randomly arranged thereon, and then the image of the surface of the label 4 is recorded again after the raised structures 43 are provided. By comparing the differences between images before and after the provision of the raised structures 43, the user can clearly identify the raised structures 43.

(S30) A mobile device connecting to the system database via an application to obtain the distribution information of the raised structures corresponding to the label serial number of a label to be tested.

An application of the mobile device 2 connects to the system database 1, and obtains the distribution information of the raised structures 43 corresponding to the label serial number 41 of a label to be tested 3, and simultaneously displays it on the screen of the mobile device 2 for the user to look at. The connection information for connecting the application of the mobile device 2 to the system database 1 can be pre-stored in the application or manually selected/inputted by the user. Input herein means entering the connection information via a physical keyboard, a virtual keyboard, or a touch panel of the mobile device 2 or by speech input. Alternatively, the connection information can be obtained by scanning a barcode, Alternatively, the label to be tested 3 is equipped with a RFID tag that includes the connection information for connecting to the system database 1. In other words, the mobile device 2 may obtain the connection information. via a RFID reader and connect automatically to the system database 1. it should be noted that the aforementioned application may exist in the mobile device 2 in the form of a hardware, a software or a firmware. The hardware means that the application is represented by the electronic elements that are assembled and then combined with a microprocessor (e.g. a single chip) to achieve a specific function (and the system database 1 of the present invention); the firmware means that the application. is written on a rewritable memory of the mobile device, fix example, in the way BIOS is thrilled; and the software means that the application is stored in a storage media (e.g. a hardware, a flash memory or etc. of the mobile device), and then read and executed by a predetermined processor of the mobile device 2. Regardless of whether the application is implemented as a hardware, a software or a firmware, its status or the distribution information obtained will be displayed on the screen of the mobile device 2, and can be selected and manipulated through the input device.

(S40) Performing label visual recognition, tactile recognition and distribution information recognition of the raised structures.

(S50) The application analyzing the distribution information of the raised structures of the label to be tested, and comparing it with the distribution information from the system database to create a rating information.

It should be noted that the two distribution information mentioned later refer to the distribution information of the raised structures 43 of the label to be tested 3, and the distribution information of the raised structures 43 stored in the system database 1. For simplicity and ease of description, when distribution information defined in this paragraph are mentioned in the same context, the phrase “two distribution information” would be used.

In the step above, the application obtains the distribution information of the raised structures 43 of the label to be tested 3 using the photographic lens, and then determines the degree of similarity between the two distribution information using processes such as image correction, image background removal, features extraction, features identification to provide a rating of the two distribution information (such as the degree of similarity, the degree of approximation or a fraction, a percentage or a grade (A, B, C, D, E . . . ) of difference, or inconclusive) to the user. The comparison parameters include the distribution locations, the sizes, the shapes, the distances of the raised structures 43, the relative locations among the raised structures, the relative locations of the raised structures scattered on the label to be tested 3 or the label. As mentioned earlier, the distribution information in the system database 1 can be 3D images, so when the camera of the mobile device 2 is capable of obtaining 3D images, the distribution information of the raised structures 43 of the label to be tested 3 can also be 3D images. In this case, the application is also capable of comparing the two distribution information of the 3D images.

(S60) The user determining if the raised structures of the label to be tested and the distribution information of the raised structures provided by the system database are the same by visual recognition.

In the above step, the two distribution information are displayed. by the application of the mobile device 2 for comparison by the user. Once the application obtains the two distribution information from step (S50), the screen of the mobile device displays the two distribution information side by side or one on top of the other, for example, through image processing such as distortion correction, image resolution adjustment and the like, and the images can be simultaneously or individually enlarged, rotated, flipped, and etc, for providing more details to the user to facilitate comparison.

(S70) The user determining if the raised structures of the label to be tested and the distribution information of the raised structures provided. by the system database are the same by tactile recognition.

In the above step, the user touches the label to be tested 3 to see if there are indeed protruding parts thereon to determine the existence of the raised structures on the label to be tested 3, and the corresponding shapes and locations of the raised structures of the two distribution information match with each other, and furthermore, the mobile device 2 may use a pressure (touch) sensitive scanning equipment to scan the raised structures 43 and generate the distribution information of the raised structures 43. Then, the application compares to see if the two distribution information are the same.

If they are the same, then proceed to step (S80), wherein the product with the label to be tested 3 is determined to be authentic; else, proceed to step (S81), wherein the product with the label to be tested 3 is determined to be fake.

In the above steps, after the user compares the two distribution information visually and determines the raised structures 43 included in the two distribution information are distributed differently, the product is tagged as a possible counterfeit; or after the user determines that the purportedly raised structures 43 of the label to be tested 3 actually do not feel like they are raised by touching, the product is also tagged as a possible counterfeit; on the other hand, if the recognition tests are successful, then the product to which the label to be tested 3 is attached is considered authentic. As a result, a better anti-forgery mechanism is achieved.

The method of the present invention described above, in actual implementation, can also be used in conjunction with any anti-forgery mechanisms that involve planar images, textures, serial number control or color changing to raise the difficulty and complexity for forgery, realizing a better anti-forgery system.

In summary, the shortcoming of causing confusions to Observers by producing visually similar labels using photographic reproduction techniques in the prior art is alleviated with the tactile anti-forgery method using random raised structures of the present invention by further providing a tactile sensation to users with the use of random raised structures to increase the effect of anti-forgery. In view of this, the present invention is submitted to be novel and non-obvious and a patent application is hereby filed in accordance with the patent law. It should be noted that the descriptions given above are merely descriptions of preferred embodiments of the present invention, various changes, modifications, variations or equivalents can be made to the invention without departing from the scope or spirit of the invention. It is intended that all such changes, modifications and variations fall within the scope of the following appended claims and their equivalents.

What is claimed is:

1. A tactile anti-forgery method using, random raised structures, comprising the following steps of:
generating a plurality of labels that can be attached to predetermined. products, each label including a unique label serial number, a label planar printed pattern and a plurality of raised structures randomly arranged on the label surface;
establishing distribution information of the raised structures corresponding to the various label serial numbers in a system database;
allowing a mobile device to connect to the system database via an application to obtain the distribution information of the raised structures corresponding to the label serial number on a label to be tested on a product;
performing label visual recognition, tactile recognition and distribution information recognition of the raised structures; and
allowing a user to determine if the raised structures of the label to be tested and the distribution information of the raised structures provided by the system database are the same by visual recognition;
allowing the user to determine if the raised structures of the label to be tested and the distribution information of the raised structures provided by the system database are the same by tactile recognition; and
the user determining the product with the label to be tested is authentic when the visual recognition and the tactile recognition indicate the raised structures of the label to be tested and that provided by the system database are the same; else, the product is counterfeit.

2. The tactile anti-forgery method using random raised structures of claim 1, wherein in the step of “generating a plurality of labels that can be attached to products, each label including a unique label serial number, a label planar printed pattern and a plurality of raised structures randomly arranged on the label surface”, the system database records the label planar printed pattern and images of the surface of the label where the raised structures are randomly provided thereon, forming the distribution information of the raised structures.

3. The tactile anti-forgery method using random raised structures of claim 1, wherein the raised structures include providing a plurality of predetermined three-dimensional (3D) structures on the surface of the label, and each 3D structure has a size that allows visual or tactile identification of its quantity, location and size by a person.

4. The tactile anti-forgery method using random raised structures of claim 2, wherein the label planar printed pattern has a fixed style, and the label planar printed pattern is used for displaying the label serial number, a product name, a logo, providing connection information required for connecting with the predetermined system database or a description of the raised structures, allowing the user to know the label planar printed pattern in advance and clearly identify the raised structures in the image of the label.

5. The tactile anti-forgery method using random raised structures of claim 2, wherein the label planar printed pattern has no fixed style, and the image of the surface of the label is recorded before the raised structures are randomly arranged thereon, and then the image of the surface of the label is recorded again after the raised structures are provided, and by comparing the differences between images before and after the provision of the raised structures, the user is able to clearly identify the raised structures.

6. The tactile anti-forgery method using random raised structures of claim 1, wherein in the step of “performing label visual recognition, tactile recognition and distribution information recognition of the raised structures”, the application obtains the distribution information of the raised structures of the label to be tested using a photographic module provided in the mobile device.

7. The tactile anti-forgery method using random raised structures of claim 6, wherein the application performs image processing on the distribution information of the raised structures of the label to be tested and the distribution information provided by the system database, so that when the distribution information of these raised structures are displayed on a screen of the mobile device, the will have the same viewing conditions, allowing the user to compare to see if they match with each other on the screen of the mobile device.

8. The tactile anti-forgery method using random raised structures of claim 6, wherein the step of “performing label visual recognition, tactile recognition and distribution information recognition of the raised structures” further includes allowing the application to analyze the distribution information of the raised structures of the label to be tested, and compare it with the distribution information in the system database to create a rating information, its comparison parameters includes the distribution locations, the sizes, the shapes, and the distances of the raised structures, the relative locations among the raised structures, and the relative locations of the raised. structures on the label.

9. The tactile anti-forgery method using random raised structures of claim 8, wherein the application uses image processing techniques including image correction, image background removal, features extraction, features identification and determination of the degree of approximation to create the rating information.

10. The tactile anti-forgery method using random raised structures of claim 1, wherein in the step of “allowing a mobile device to connect to the system database via an application to obtain the distribution information of the raised structures corresponding to the label serial number on a label to be tested on a product”, the application of the mobile device connects to the system database, and the label serial number of the label to be tested is inputted to obtain the distribution information of the corresponding raised structures.
